(19) United States
(12) Patent Application Publication
(10) Pub. No.: US 2016/0234259 A1
(43) Pub. Date: Aug. 11, 2016

(54) MACHINE COMMUNICATION USING A MULTI-STAGE SUITABILITY ALGORITHM

(71) Applicant: Caterpillar Inc., Peoria, IL (US)

(72) Inventors: SANAT ARUN TALMAKI, PEORIA, IL (US); JASON SMALLENBERGER, MORTON, IL (US)

(73) Assignee: CATERPILLAR INC., Peoria, IL (US)

(21) Appl. No.: 14/617,625

(22) Filed: Feb. 9, 2015

(51) Int. Cl. H04L 29/06; H04L 12/24

(52) U.S. Cl. CPC H04L 65/1069; H04L 41/08

(57) ABSTRACT

System and methods for managing an equipment fleet including one or more machines are disclosed. One method includes receiving first information relating to an availability of one or more machines of a plurality of machines, receiving second information relating to a machine role of the one or more machines, receiving third information relating to a pairing state of the one or more machines, and determining a suitable pairing for at least one of the plurality of machines based upon at least the first information, the second information, and the third information.

### TECHNICAL FIELD

This patent disclosure relates generally to management of an equipment fleet and more particularly to methods and systems for pairing various machines in an equipment fleet.

### BACKGROUND

In a field, such as a quarry, where a plurality of machines such as dump trucks and loaders are systematically operated within a relatively wide working area, the machines usually operate in cooperation with each other. For example, when a dump truck without a load enters the quarry and stops near an operator-waiting loader, the loader loads stones, rocks, earth, and/or sand on a bed (hereinafter, referred to as a body) of the dump truck. After loading up to a maximum allowable load weight (hereinafter, referred to as a rated load weight), an operator of the loader sends a signal of load completion with a horn, etc., to an operator of the dump truck, and waits for the next dump truck without a load to arrive. The operator of the dump truck carries the loaded stones, rocks, earth, sand, etc., to a predetermined earth dumping field to discharge them, and then returns to the quarry to repeat the above operating procedure.

As an example, U.S. Pat. No. 5,822,224 discloses pairing communications between a loader and a haul unit. U.S. Pat. No. 5,822,224 describes a loader selecting means (2) is provided for each dump truck, and a plurality of channels are provided for each dump truck controller (6) and each loader controller (35), the dump truck controller (6) inputs a loader selection signal from the loader selecting means (2), and selects, from a plurality of channels, a channel available for communicating with the loader controller (35) corresponding to the loader selection signal to transmit a load weight value, and the selected loader controller (35) receives the load weight value on the channel available for communications, and displays the received load weight value on a weight display means (32). However, such control is not informed by the suitability of a particular machine to work in concert with other machines.

These and other shortcomings of the prior art are addressed by the present disclosure.

### SUMMARY

This patent disclosure relates to system and methods for managing an equipment fleet including one or more machines. In another aspect, a method may include receiving first information relating to an availability of one or more machines of a plurality of machines, receiving second information relating to a machine role of the one or more machines, receiving third information relating to a pairing state of the one or more machines, and determining a suitable pairing for at least one of the plurality of machines based upon at least the first information, the second information, and the third information.

In another aspect, a system may include a processor and a memory bearing instructions that, upon execution by the processor, cause the system at least to: receive first information relating to an availability of one or more machines of a plurality of machines, receive second information relating to a machine role of the one or more machines, receive third information relating to a pairing state of the one or more machines, and determine a suitable pairing for at least one of the plurality of machines based upon at least the first information, the second information, and the third information.

In yet another aspect, a method may include receiving first information relating to an availability of one or more machines of a plurality of machines, receiving second information relating to a machine role of the one or more machines, receiving one or more of third information relating to a pairing state of the one or more machines and fourth information relating to a positional state of the one or more machines, determining a suitable pairing for at least one of the plurality of machines based upon at least the first information, the second information, and the third information, and establishing a pairing between two or more of the plurality of machines.

### BRIEF DESCRIPTION OF THE DRAWINGS

FIG. 1 is a block diagram of an exemplary system and network in accordance with aspects of the disclosure.

FIG. 2 is a block diagram of an exemplary system and network in accordance with aspects of the disclosure.

FIG. 3 is a block diagram of an exemplary system and network in accordance with aspects of the disclosure.

FIG. 4 is a flow chart of an exemplary method in accordance with aspects of the disclosure.

FIG. 5 is a block diagram of a computer system configured to implement the method of FIG. 4.

### DETAILED DESCRIPTION

In accordance with aspects of the disclosure, systems and methods provide a communications tool for identifying and selecting suitable partner machines for pairing to accomplish tandem work. As an example, a multi-stage suitability algorithm may leverage machine availability, machine role (e.g., loader, hauler, grader, etc.), pairing status (e.g., currently paired with another machine or not), and positional state (e.g., location, heading, proximity to another machine performing suitability analysis, etc.) to provide a determination of one or more partner machines.

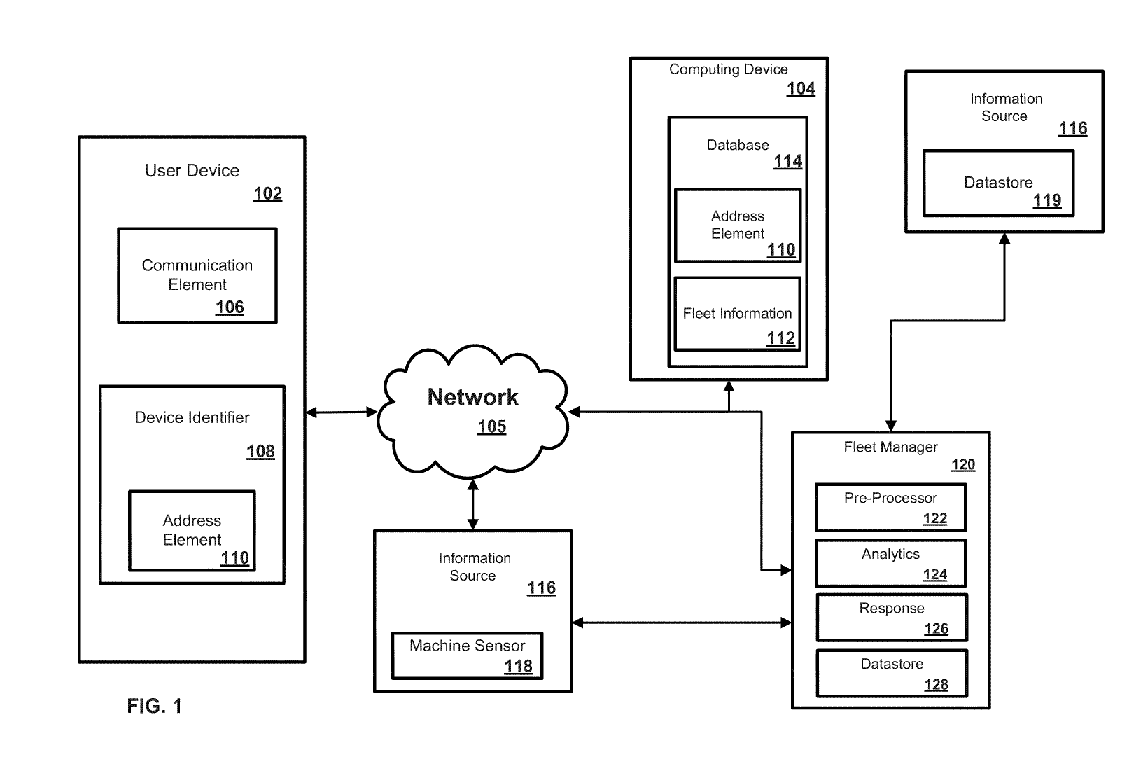

FIG. 1 illustrates various aspects of an exemplary network in which the present methods and systems may operate. The present disclosure is relevant to systems and methods for managing a network, for example. Those skilled in the art will appreciate that present methods may be used in various types of networks and systems that employ both digital and analog equipment. The system is described as including elements. An element may be software, hardware, or a combination of software and hardware. One skilled in the art will appreciate that provided herein is a functional description and that the respective functions may be performed by software, hardware, or a combination of software and hardware.

The system and network may include a user device 102 (e.g., physical computer host, virtual machine, IP-capable device) in communication with a computing device 104 such as a server or Network Interface Device (NID), for example. The computing device 104 may be disposed locally, or remotely, relative to the user device 102. As an example, the user device 102 and the computing device 104 may be in communication via a private and/or public network 105 such as the Internet. Other forms of communications may be used such as wired and wireless telecommunication channels that operate over a communication channel as defined herein, for example.

In an aspect, the user device 102 may be an electronic device such as a computer, a smartphone, a laptop, a tablet, a display device, or other device capable of communicating with the computing device 104. The user device 102 may be configured to communicate information relating to a user, such as an operator of a machine or equipment. The user device 102 may be configured to determine and communicate information relating to another device such as the machine itself. For example, an operator of a machine such as a hydraulic mining shovel, excavator, wheel loader, cable shovel, bucket wheel, bulldozer, and the like may interact with the user device 102 to capture information relating to the operation of the machine. Such information may include operational information (e.g., machine models, hours on each machine, etc.), availability for tasking, pairing status, role status, positional information, machine service history, predicted annual usage of each machine, parts lists, labor hours to repair/replace parts, labor hourly cost, downtime to repair/replace parts, predicted component life, preventative maintenance schedules, and predicted fleet life cycles. Any information may be stored in and retrieved from the database 114.

In an aspect, the user device 102 may include a communication element 106 for providing an interface to a user to interact with the user device 102 and/or the computing device 104. The communication element 106 may be any interface for presenting information to the user and receiving user feedback, such as a web browser (e.g., Internet Explorer, Mozilla Firefox, Google Chrome, Safari, or the like) or proprietary software, for example. Other software, hardware, and/or interfaces may be used to provide communication between the user and one or more of the user device 102 and the computing device 104. As an example, the communication element 106 may request or query various files from a local source and/or a remote source. As a further example, the communication element 106 may transmit data to a local or remote device such as the computing device 104.

In an aspect, the user device 102 may be associated with a user identifier or device identifier 108. As an example, the device identifier 108 may be any identifier, token, character, string, or the like, for differentiating one user or user device (e.g., user device 102) from another user or user device. In a further aspect, the device identifier 108 may identify a user or user device as belonging to a particular class of users or user devices. As a further example, the device identifier 108 may include information relating to the user device, such as a manufacturer, a model or type of device, a service provider associated with the user device 102, a state of the user device 102, a locator, and/or a label or classifier. Other information may be represented by the device identifier 108. The device identifier 108 may be used for authentication of a user/user device to manage access to particular services or information.

In an aspect, the device identifier 108 may include an address element 110 such as an internet protocol address, a network address, an Internet address, or the like. As an example, the address element 110 may be relied upon to establish a communication session between the user device 102 and the computing device 104 or other devices and/or networks. As a further example, the address element 110 may be used as an identifier or locator of the user device 102.

In an aspect, the computing device 104 may be a server for communicating with the user device 102, other computing devices 104, and/or physical or logical components including, for example, machine sensors (e.g., machine sensor 118). As an example, the computing device 104 may communicate with the user device 102 for providing services such as peer-to-peer communication and machine pairing services. In an aspect, the computing device 104 may allow the user device 102 to interact with remote resources, such as data, devices, files, and computing elements associated with one or more machines. As an example, the computing device may be configured as computing module for a particular machine. As such, the user device 102 may interact with the computing device 104 to control the machine and/or to retrieve information relating to the machine. As a further example, the computing device 104 may interact with other computing devices 104 to effect communication (e.g., peer-to-peer, broadcast, unicast, multicast, etc.) between one or more machines in a fleet.

In an aspect, the computing device 104 may manage the communication between the user device 102 and a database 114 for sending and receiving data therebetween. As an example, the database 114 may store a plurality of files, webpages, user identifiers or records, or other information. As a further example, the user device 102 may request and/or retrieve a file from the database 114. In an aspect, the database 114 may store information relating to the user device 102, such as the address element 110 and/or fleet information 112. Fleet information 112 may be operational information (e.g., machine models, hours on each machine, etc.), availability for tasking, pairing status, role status, positional information, machine service history, predicted annual usage of each machine, parts lists, labor hours to repair/replace parts, labor hourly cost, downtime to repair/replace parts, predicted component life, preventative maintenance schedules, and predicted fleet life cycles. Any information may be stored in and retrieved from the database 114. The database 114 may be disposed remotely from the computing device 104 and accessed via direct or indirect connection. The database 114 may be integrated with the computing device 104 or some other device or system.

In an aspect, an information source 116 may be configured to receive or access various information. As an example, the information source 116 may configured to receive or access information from one or more of a predictive model, weather information source, equipment list source, geological information source, dealership or service center, a machine operator and/or the like. As another example, the information source 116 may include a machine sensor 118 for continuously or periodically measuring operational parameters of one or more machines. Operational parameters may include availability of the machine for tasking, pairing status, machine role, positional state, and/or the like. Operational parameters may include average operating time between machine stoppages, average downtime for machine stoppages, percentage of total downtime hours performed in a given period that have been planned and scheduled, ratio of time that a machine is capable of functioning in the intended operation (available hours) to total hours in the period under consideration (typically either based on calendar or scheduled hours), ratio of average shutdown frequency to the sum of average shutdown frequency and average shutdown duration, proportion of time that a machine is operating (operating hours) divided by the total calendar time in the period.

As a further example, one or more of the information sources 116 may include a datastore 119 for storing information such as operational information (e.g., machine models, hours on each machine, etc.), availability for tasking, pairing status, role status, positional information, machine service history, predicted annual usage of each machine, parts lists, labor hours to repair/replace parts, labor hourly cost, downtime to repair/replace parts, predicted component life, preventative maintenance schedules, and predicted fleet life cycles.

In an aspect, a fleet manager 120 may be configured to receive information from at least the information source 116, process the received information, and provide feedback relating to the received information. The fleet manager 120 may be accessed by one or more of the user devices 102 and the computing devices 104 and by be integrated as hardware or logic into various devices and/or processing elements. The fleet manager 120 may be included in one or more machines for localized processing or may be centrally located for network processing.

In an aspect, the fleet manager 120 may include a pre-processor component 122 configured to receive data from various sources such as one or more computing nodes (e.g., computing device 104) and the information source 116. As an example, the pre-processor component 122 may be configured to receive a data dump of information and/or may be configured to process the received or accessed data to filter at least a portion of the received or accessed data. As a further example, the pre-processor component 122 may be configured to filter/classify received information based on one or more parameters such as a location, source identifier, jobsite plan, maintenance plan, available resources, and the like.

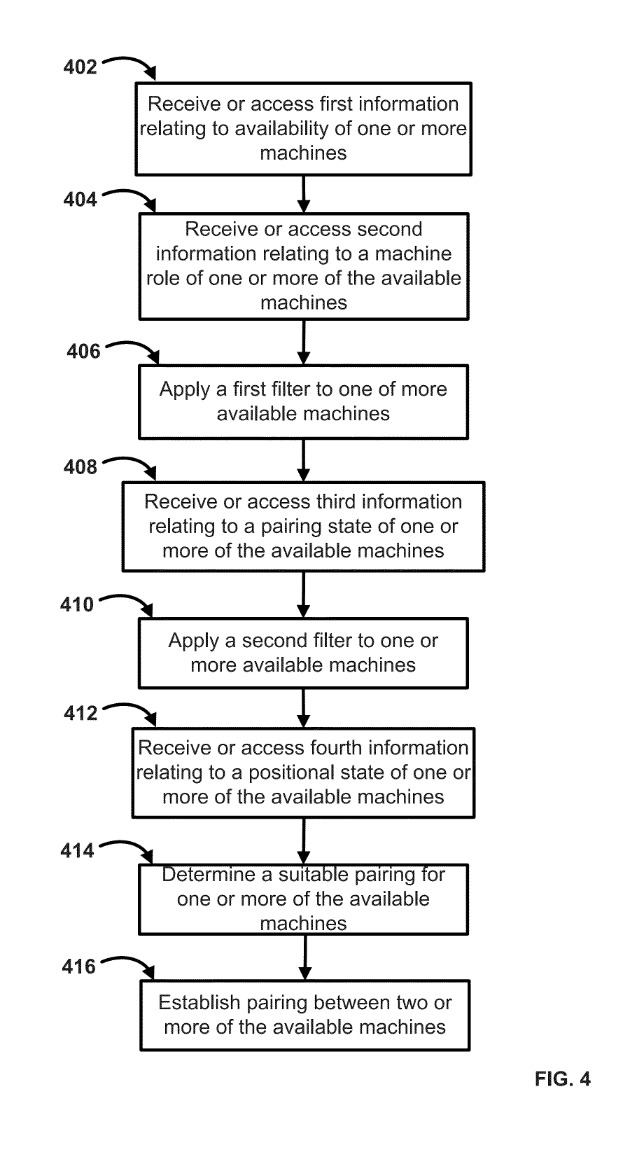

The fleet manager 120 may include an analytics component 124 configured to access or receive data (communication flows), for example, from the pre-processing component 122 or other datasource. The analytics component 124 may be configured to analyze the received data, for example, using statistical analysis, comparative analysis, and/or a machine learning algorithm to assess the current status of a fleet of one or more machines. As an example, the analytics component 124 may be configured to process one or more operations such as described in FIG. 4 to determine a suitability of pairing one or more machines for tandem work. As another example, the analytics component 124 may be configured to compare the received data against a predictive model for the one or more machines. The analytics component 124 may be configured to analyze the received data based on one or more of site performance vs. corporate or industry baseline, work order analysis, life cycle position on a machine and/or component basis, labor analysis, parts inventory, oil sampling (SOS) history, vendor relationships, total equipment life-cycle cost, electronic equipment data or on-board equipment data, and preventative maintenance information. In an aspect, the analytics component 124 may be configured to compare received data to stored data (e.g., historical data). As an example, the comparison may include identifying signatures and/or patterns in the received data.

In an aspect, a response component 126 may be configured to provide assessments and recommendations based on the analysis conducted by the analytics component 124. The assessments and recommendation may include a fleet summary, component/machine risk assessment, updates to the predictive maintenance model, pairing recommendations, and updates to jobsite plans. Received or accessed information, classifications, statistics, and/or remediation logs may be stored in a datastore 128. The response component 126 may be configured to autonomously update information relating to one or more machines such as a machine role, availability state, and/or pairing status.

As an illustrative example, where there are multiple loaders working in a given area and loader 1 just started loading a truck 1 and loader 2 has one remaining pass in truck 2, the next truck N in line or approaching an area may be directed to loader 2. However, if loader 2 goes on break or is taken out of the scenario, then all remaining trucks may be assigned to loader 1. If the material type being loaded is dynamically identified, machines, such as trucks, may be routed based on this information. For example, if material is designated as spoil, then the trucks loaded with spoil may be automatically directed to the spoil area. As another example, when moisture content of material, certain machines may be paired to handle the scenario, such as paring a water truck to manage dry soil or pairing compactors to compress soil at a particular moisture level.

As a further example, in the course of operations, a hauling machine may experience an obstacle in its haul path/route. As such, the hauling machine may request a motor grader (or similar unit) to clear the obstacle by flagging a warning and assigning task/role to the motor grader. Thus, the logic (on-board or through a back-office) is capable of assigning new roles to other units.

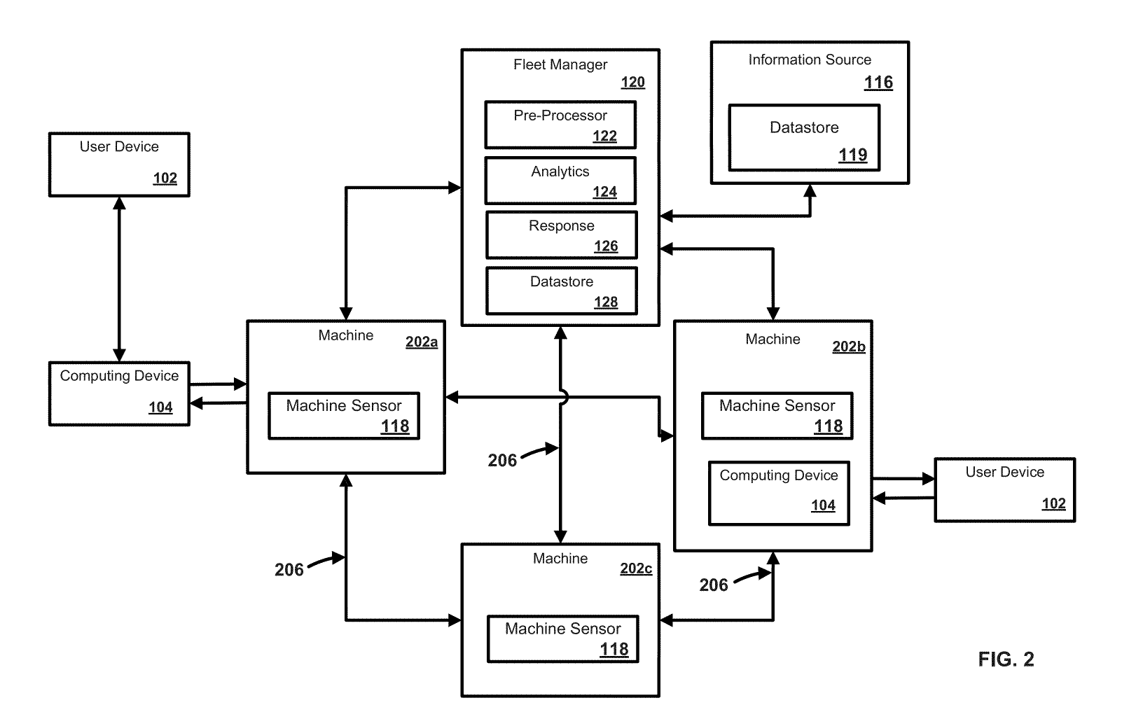

FIG. 2 illustrates an exemplary system and network. In an aspect, a plurality of machines 202a, 202b, 202c may be in communication with one or more user devices 102 and/or one or more computing devices 104. In certain aspects, one or more of the user device 102 and the computing device 104 may be disposed in one or more of the machines 202a, 202b, 202c. As shown in FIG. 2, the information source 116 and fleet manager 120 may be configured to monitor and manage resources such as the machines 202a, 202b, 202c. As an example, the information source 116 and/or fleet manager 120 may be disposed in one or more of the machines 202a, 202b, 202c or remotely accessed therefrom.

The machines 202a, 202b, 202c may include hydraulic mining shovels, excavators, wheel loaders, cable shovels, bucket wheels, bulldozers, and draglines that are commonly used in the construction and mining industries to dig, excavate, move, and load materials, such as rock soil, overburden, and ore during mining and construction processes. Other machines may be used such as backhoes, multi-track loaders, skid-steers, and material handlers. As an example, one or more user devices 102 may be an electronic device, such as a computer, a smartphone, a laptop, a tablet, a display device, or other device capable of communicating with one or more of the machines 202a, 202b, 202c of the network. As a further example, one or more computing devices 104 may be a server or a gateway.

In an aspect, one or more of the machines 202a, 202b, 202c may be configured to communicate with at least one of the other of the machines 202a, 202b, 202c and/or one or more of the computing devices 104 via one or more communication paths 206 that may use a communication channel such as direct peer-to-peer channels, communication through back office using cellular or Wi-Fi connectivity, multi-hop mesh networks that allow signals to hop over intermediate devices to reach the final destination, or other channels such as those defined herein. One or more of the machines 202a, 202b, 202c may include one or more machine sensors 118 configured to measure operational parameters of the associated machines 202a, 202b, 202c.

In certain aspects, the fleet manager 120 may access or receive information from various sources such as the machines 202a, 202b, 202c, the computing devices 104, the user devices 102, and/or the information sources 116. The fleet manager 120 may be configured to determine pairings of two or more machines based upon the received information. As an example, the fleet manager 120 may be disposed in each of the machines 202a, 202b, 202c and may continuously or periodically receive information such as position, speed, direction of travel, machine role, availability for tasking, pairing status, and/or other information. Each of the fleet managers 120 may process the received information to make a determination of which of the machines 202a, 202b, 202c should be paired together to accomplish one or more tasks. Once certain ones of the machines 202a, 202b, 202c are paired, the machines 202a, 202b, 202c may share detailed operation specific information such as payload, number of passes remaining, and site operation updates, for example, and may enhance the overall worksite processes that can be optimized through Machine-to-Machine (M2M) communication.

### INDUSTRIAL APPLICABILITY

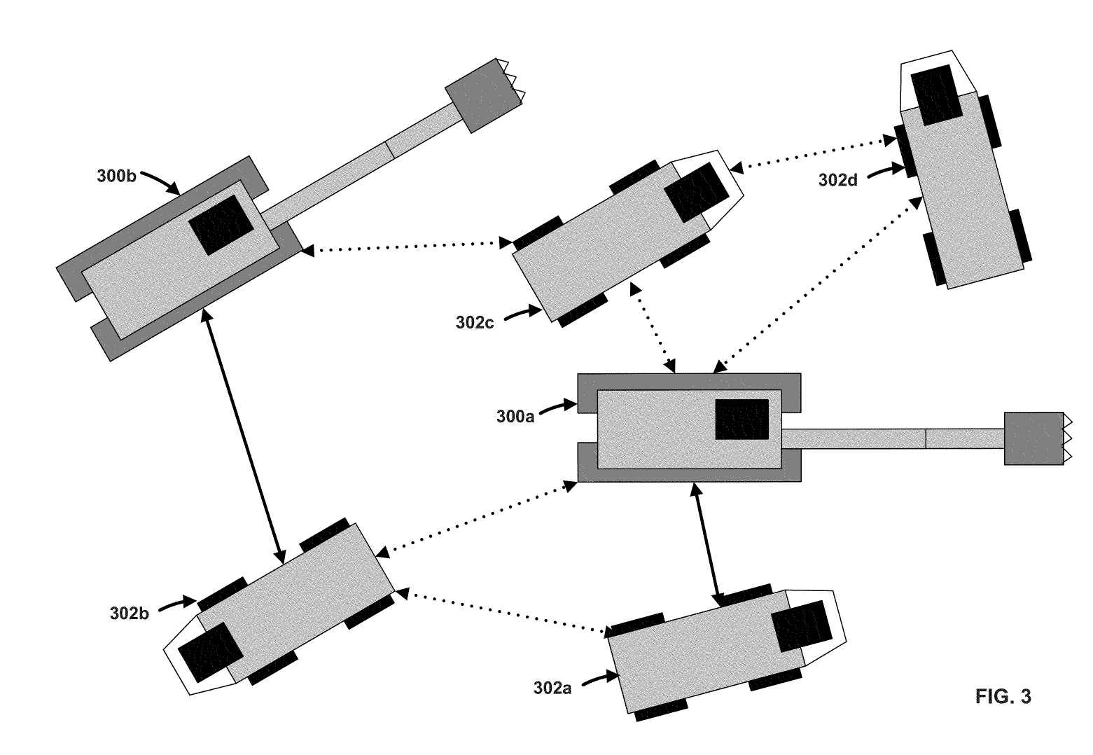

Machines, such as hydraulic mining shovels, excavators, wheel loaders, cable shovels, bucket wheels, bulldozers, draglines, backhoes, multi-track loaders, skid-steers, material handlers and the like are commonly used in the construction and mining industries to dig, excavate, move, and load materials, such as rock soil, overburden, and ore during mining and construction processes. In heavy duty applications, these machines may weigh 1,500 tons or more. FIGS. 3 and 4 provide an illustrative example of operating procedures that may be used to manage an equipment fleet including one or more machines. Such management may include pairing two or more of the machines with each other in order to effect tandem work tasks such as loading and hauling.

FIG. 3 illustrates a site layout including a plurality of machines 300, 302, which may be similar to machines 202a, 202b, 202c illustrated in FIG. 2. As shown, each of a plurality of loading machines 300a, 300b may communicate with each other and with each of a plurality of hauling machines 302a, 302b, 302c, 302d. Likewise, each of the hauling machines 302a, 302b, 302c, 302d may communicate with each other and each of the loading machines 300a, 300b. In certain aspects, one or more the loading machines 300a, 300b and/or one or more of the hauling machines 302a, 302b, 302c, 302d may transmit (e.g., broadcast, unicast, multicast, etc.) information such as position, speed, and equipment details with any other machine 300, 302 or receiver within receiving proximity. For certain operations that require a pair of machines to be associated with one-another, such as one of the loading machines 300a loading material into one of the hauling machine 302a, a suitability of the pairing of such machines 300, 302 may be determined. While certain examples relate to a loading/hauling operation, the applicability of the pairing process of the present disclosure is not limited to loading/hauling type operations and as such can be extended to any operation involving a combination of equipment working in tandem.

FIG. 4 depicts exemplary operating procedures that may be implemented by the systems and networks described herein. For example, in reference to FIGS. 3 and 4, operation or step 402 may include receiving or accessing first information. In an aspect, one or more of the machines 300, 302 may receive or access first information relating to an availability of the one or more of the machines 300, 302 for tasking, such as pairing. For example, the first information may include machine operation information such as proximity to other machines, maintenance schedule, current site tasks, operator information, and the like. As a further example, the first information may relate to the availability of a particular machine to accomplish a particular task, such as hauling.

In operation or step 404, second information may be received or accessed. In an aspect, the second information may relate to a machine role of one or more of the available machines 300, 302. In certain aspects, one or more of the machines 300, 302 may receive or access second information relating to a designated machine role of the one or more machines 300, 302. As an example, one or more the machines 300, 302 may be assigned a role such as loading, hauling, grading, compacting, clearing, and other operations. These roles can be assigned by the site foreman or by the operator based on the site setup specifics. Such roles may be assigned remotely or locally to a work site and may be based on a site operation plan, for example.

In operation or step 406, a first filter may be applied to one of more available machines 300, 302 based on at least the second information. In an aspect, the first filter may relate to filtering machines based on a machine role. Such filters can be a comparative criteria against which particular machine information is compared. For example, the available machines for pairing with the loading machine 300a may include the loading machine 300b and hauling machines 302a, 302b, 302c, 302d. Using the first filter, defining a criteria of “machine role=hauling,” the loading machine 300b may be eliminated as a loading tool that cannot pair with another loading tool to perform its task. Accordingly, the remaining available machines for pairing may include hauling machines 302a, 302b, 302c, 302d.

In operation or step 408, third information may be received or accessed. In an aspect, the third information may relate to a pairing state of one or more of the available machines 300, 302. As an example, one or more of the machines 300, 302 may be available to be paired with another of the machines 300, 302 unless it is already paired with another of the machines 300, 302. In this example, machine pairing is one-to-one, however, other pairing rules and ratios may be established. As such, in operation or step 410, a second filter may be applied to the available machines based on at least the third information. Such filters can be a comparative criteria against which particular machine information is compared. For example, the available machines for pairing with the loading machine 300a may be limited by the first filter to include hauling machines 302a, 302b, 302c, 302d. Using the second filter, defining a criteria of “pairing state=unpaired,” the hauling machine 302b may be eliminated as already being paired with loading machine 300b (as illustrated by the solid pairing line). Accordingly, the remaining available machines for pairing may include hauling machines 302a, 302c, 302d.

In operation or step 412, a fourth information may be received or accessed. In an aspect, the fourth information may relate to positional state of one or more of the available machines 300, 302. Positional state information may include one or more of current location, speed, and heading (direction). Such information may be useful information for a machine that has two available pairing options at the same distance, but one is moving away, while the other one is moving towards. As such, in operation or step 414, a suitable pairing for one or more of the available machines 300, 302 may be determined based one or more of the first information, second information, third information, and fourth information. As an example, the hauling machine 302d may be eliminated because the hauling machine 302d is too far from the loading machine 300a. Hauling machines 302a, 302c may be within proximity of the loading machine 300a, but hauling machine 302a may be heading toward the loading machine 300a. Accordingly, it may be determined that the hauling machine 302a is suitable to pair with the loading machine 300a to accomplish a loading task. Such a determination may be based on filtering algorithms, computing logic, or other analytics local to the machines 300, 302 or remote therefrom. Pairing may be based on particular tasks that are to be performed and may be leveraged on various equipment in various worksites.

In operation or step 416, pairing may be established between two or more of the available machines 300, 302. As an example, the hauling machine 302a may be paired with the loading machine 300a, as identified in step 414. In an aspect, pairing may include updating a database or machine parameters to identify a pairing state and/or an identification of the paired machines. Once certain ones of the machines are paired, the machines may share detailed operation specific information such as payload, number of passes remaining, and site operation updates, for example, and may enhance the overall worksite processes.

As an illustrative example, machines may be paired based on a predetermined radius or zone, for example, based on type of machine, speed, direction, or a machine-to-machine communication method like 802.11p or 802.15.4. In certain aspects, if two or more machines machines can establish a communication link between each other, they may start to exchange information. In other aspects, when two coordinate radiuses (extending from various machines) intersect, each machine may be notified of the IP address of the other machines within the radius, thereby initiating the exchange of information. Various rules and filters may be used to control the exchange of data between machines. For example, Truck 1 may be loaded and is approaching a loading machine. Because the Truck 1 is already full, there is no need to exchange data with the loading machine. However, if the loading machine happens to be in a predetermine dump location, a more detailed exchange of data may be executed to address this particular scenario. As a further example, a hauling machine, while in the process of dumping its load, has on-board logic that seeks a machine that will spread the dumped dirt. Thus, the hauling machine may pair itself with an unpaired spreading machine such as a tractor (bulldozer) or motor grader that is within proximity (e.g., intersecting radius). Once the spreading machine is paired, the hauling machine may share additional detailed information such as quantity or load, material type, moisture content, etc.

Those of skill will appreciate that the various illustrative logical blocks, modules, and algorithm steps described in connection with the aspects disclosed herein may be implemented as electronic hardware, computer software, or combinations of both. To clearly illustrate this interchangeability of hardware and software, various illustrative components, blocks, modules, and steps have been described above generally in terms of their functionality.

Whether such functionality is implemented as hardware or software depends upon the design constraints imposed on the overall system. Skilled persons may implement the described functionality in varying ways for each particular application, but such implementation decisions should not be interpreted as causing a departure from the scope of the disclosure. In addition, the grouping of functions within a module, block, or step is for ease of description. Specific functions or steps may be moved from one module or block without departing from the disclosure.

The various illustrative logical blocks and modules described in connection with the aspects disclosed herein may be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor (e.g., of a computer), or in a combination of the two. A software module may reside, for example, in RAM memory, flash memory, ROM memory, EPROM memory, EEPROM memory, registers, hard disk, a removable disk, a CD-ROM, or any other form of storage medium. An exemplary storage medium may be coupled to the processor such that the processor may read information from, and write information to, the storage medium. In the alternative, the storage medium may be integral to the processor. The processor and the storage medium may reside in an ASIC.

In at least some aspects, a processing system (e.g., electronic control system 200) that implements a portion or all of one or more of the technologies described herein may include a general-purpose computer system that includes or is configured to access one or more computer-accessible media.

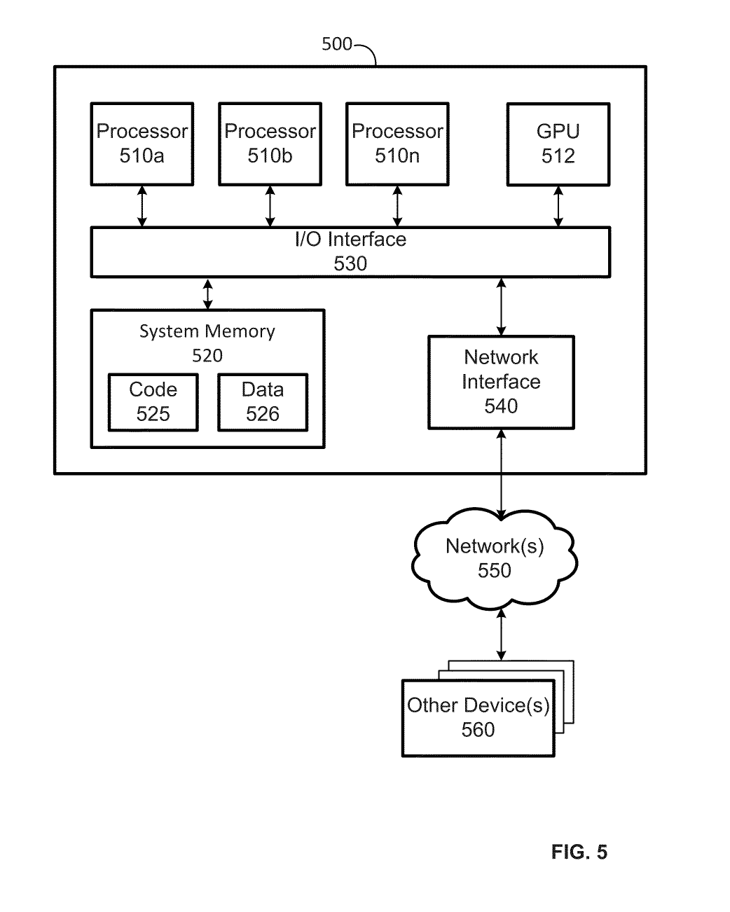

FIG. 5 depicts a general-purpose computer system that includes or is configured to access one or more computer-accessible media. In the illustrated aspect, a computing device 500 includes one or more processors 510a, 510b, and/or 510n (which may be referred herein singularly as a processor 510 or in the plural as the processors 510) coupled to a system memory 520 via an input/output (I/O) interface 530. Computing device 500 further includes a network interface 540 coupled to the I/O interface 530.

In various aspects, computing device 500 may be a uniprocessor system including one processor 510 or a multiprocessor system including several processors 510 (e.g., two, four, eight, or another suitable number). Processors 510 may be any suitable processors capable of executing instructions. For example, in various aspects, the processor(s) 510 may be a general-purpose or embedded processors implementing any of a variety of instruction set architectures (ISAs), such as the x86, PowerPC, SPARC, or MIPS ISAs, or any other suitable ISA. In multiprocessor systems, each of the processors 510 may commonly, but not necessarily, implement the same ISA.

In some aspects, a graphics processing unit (“GPU”) 512 may participate in providing graphics rendering and/or physics processing capabilities. A GPU may, for example, include a highly parallelized processor architecture specialized for graphical computations. In some aspects, the processors 510 and the GPU 512 may be implemented as one or more of the same type of device.

System memory 520 may be configured to store instructions and data accessible by the processor(s) 510. In various aspects, the system memory 520 may be implemented using any suitable memory technology, such as static random access memory (“SRAM”), synchronous dynamic RAM (“SDRAM”), nonvolatile/Flash®-type memory, or any other type of memory. In the illustrated aspect, program instructions and data implementing one or more desired functions, such as those methods, techniques and data described above, are shown stored within system the memory 520 as code 525 and data 526.

In one aspect, the I/O interface 530 may be configured to coordinate I/O traffic between the processor(s) 510, the system memory 520 and any peripherals in the device, including the network interface 540 or other peripheral interfaces. In some aspects, the I/O interface 530 may perform any necessary protocol, timing or other data transformations to convert data signals from one component (e.g., system memory 520) into a format suitable for use by another component (e.g., processor 510). In some aspects, the I/O interface 530 may include support for devices attached through various types of peripheral buses, such as a variant of the Peripheral Component Interconnect (PCI) bus standard or the Universal Serial Bus (USB) standard, for example. In some aspects, the function of the I/O interface 530 may be split into two or more separate components, such as a north bridge and a south bridge, for example. Also, in some aspects some or all of the functionality of the I/O interface 530, such as an interface to the system memory 520, may be incorporated directly into the processor 510.

Network interface 540 may be configured to allow data to be exchanged between the computing device 500 and other device or the devices 560 attached to a network or networks 550, such as other computer systems or devices, for example. In various aspects, the network interface 540 may support communication via any suitable wired or wireless general data networks, such as types of Ethernet networks, for example. Additionally, the network interface 540 may support communication via telecommunications/telephony networks on a communication channel is defined herein, such as analog voice networks or digital fiber communications networks, via storage area networks, such as Fibre Channel SANs (storage area networks), or via any other suitable type of network and/or protocol.

In some aspects, the system memory 520 may be one aspect of a computer-accessible medium configured to store program instructions and data as described above for implementing aspects of the corresponding methods and apparatus. However, in other aspects, program instructions and/or data may be received, sent, or stored upon different types of computer-accessible media. Generally speaking, a computer-accessible medium may include non-transitory storage media or memory media, such as magnetic or optical media, e.g., disk or DVD/CD coupled to the computing device 500 via the I/O interface 530. A non-transitory computer-accessible storage medium may also include any volatile or non-volatile media, such as RAM (e.g., SDRAM, DDR SDRAM, RDRAM, SRAM, etc.), ROM, etc., that may be included in some aspects of the computing device 500 as the system memory 520 or another type of memory. Further, a computer-accessible medium may include transmission media or signals, such as electrical, electromagnetic or digital signals, conveyed via a communication medium, such as a network, a communication channel is defined herein, and/or a wireless link, such as those that may be implemented via network interface 540. Portions or all of the multiple computing devices, such as those illustrated in FIG. 5, may be used to implement the described functionality in various aspects; for example, software components running on a variety of different devices and servers may collaborate to provide the functionality. In some aspects, portions of the described functionality may be implemented using storage devices, network devices or special-purpose computer systems, in addition to or instead of being implemented using general-purpose computer systems. The term “computing device,” as used herein, refers to at least all these types of devices and is not limited to these types of devices.

It should also be appreciated that the systems in the figures are merely illustrative and that other implementations might be used. Additionally, it should be appreciated that the functionality disclosed herein might be implemented in software, hardware, or a combination of software and hardware. Other implementations should be apparent to those skilled in the art. It should also be appreciated that a server, gateway, or other computing node may include any combination of hardware or software that may interact and perform the described types of functionality, including without limitation desktop or other computers, database servers, network storage devices and other network devices, PDAs, tablets, cellphones, wireless phones, pagers, electronic organizers, Internet appliances, television-based systems (e.g., using set top boxes and/or personal/digital video recorders), and various other consumer products that include appropriate communication capabilities. In addition, the functionality provided by the illustrated modules may in some aspects be combined in fewer modules or distributed in additional modules. Similarly, in some aspects the functionality of some of the illustrated modules may not be provided and/or other additional functionality may be available.

Each of the operations, processes, methods, and algorithms described in the preceding sections may be embodied in, and fully or partially automated by, code modules executed by at least one computer or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto may be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example aspects. The example systems and components described herein may be configured differently than described. For example, elements may be added to, removed from, or rearranged compared to the disclosed example aspects.

It will also be appreciated that various items are illustrated as being stored in memory or on storage while being used, and that these items or portions of thereof may be transferred between memory and other storage devices for purposes of memory management and data integrity. Alternatively, in other aspects some or all of the software modules and/or systems may execute in memory on another device and communicate with the illustrated computing systems via inter-computer communication. Furthermore, in some aspects, some or all of the systems and/or modules may be implemented or provided in other ways, such as at least partially in firmware and/or hardware, including, but not limited to, at least one application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network, or a portable media article to be read by an appropriate drive or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other aspects. Accordingly, the present disclosure may be practiced with other computer system configurations.

Conditional language used herein, such as, among others, “may,” “could,” “might,” “may,” “e.g.,” and the like, unless specifically stated otherwise, or otherwise understood within the context as used, is generally intended to convey that certain aspects include, while other aspects do not include, certain features, elements, and/or steps. Thus, such conditional language is not generally intended to imply that features, elements, and/or steps are in any way required for at least one aspects or that at least one aspects necessarily include logic for deciding, with or without author input or prompting, whether these features, elements, and/or steps are included or are to be performed in any particular aspect. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example aspects have been described, these aspects have been presented by way of example only, and are not intended to limit the scope of aspects disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of aspects disclosed herein. The accompanying claims and their equivalents are intended to cover such forms or modifications as would fall within the scope and spirit of certain aspects disclosed herein.

The preceding detailed description is merely exemplary in nature and is not intended to limit the disclosure or the application and uses of the disclosure. The described aspects are not limited to use in conjunction with a particular type of machine. Hence, although the present disclosure, for convenience of explanation, depicts and describes particular machine, it will be appreciated that the assembly and electronic system in accordance with this disclosure may be implemented in various other configurations and may be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

The disclosure may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), Long Term Evolution (LTE), W-CDMA (Wideband Code-Division Multiple Access), Wireless Fidelity (Wi-Fi), Bluetooth, and/or the like, and/or a combination of two or more thereof.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

We claim:

1. A method for managing an equipment fleet comprising one or more machines, the method comprising:
receiving, by one or more processors, first information relating to an availability of one or more machines of a plurality of machines;
receiving, by the one or more processors, second information relating to a machine role of the one or more machines;
receiving, by the one or more processors, third information relating to a pairing state of the one or more machines; and
determining, by the one or more processors, a suitable pairing for at least one of the plurality of machines based upon at least the first information, the second information, and the third information.

2. The method of claim 1, wherein the first information comprises one or more of a proximity to other machines of the plurality of machines, maintenance schedule, current site tasks, operator information, and pairing capability.

3. The method of claim 1, wherein the machine roles relate to operational capabilities of the one or more machines.

4. The method of claim 1, wherein the third information comprises a paired state or an unpaired state.

5. The method of claim 1, wherein the third information comprises an identifier of machine pairings.

6. The method of claim 1, further comprising receiving, by the one or more processors, fourth information relating to a positional state of the one or more machines, wherein the suitable pairing is determined based upon at least the first information, the second information, the third information, and the fourth.

7. The method of claim 6, wherein the fourth information comprises one or more of a location, heading, and speed of the one or more machines.

8. A system comprising:
a processor; and
a memory bearing instructions that, upon execution by the processor, cause the system at least to:
receive first information relating to an availability of one or more machines of a plurality of machines;
receive second information relating to a machine role of the one or more machines;
receive third information relating to a pairing state of the one or more machines; and
determine a suitable pairing for at least one of the plurality of machines based upon at least the first information, the second information, and the third information.

9. The system of claim 8, wherein the first information comprises one or more of a proximity to other machines of the plurality of machines, maintenance schedule, current site tasks, operator information, and pairing capability.

10. The system of claim 8, wherein the machine roles relate to operational capabilities of the one or more machines.

11. The system of claim 8, wherein the third information comprises a paired state or an unpaired state.

12. The system of claim 8, wherein the third information comprises an identifier of machine pairings.

13. The system of claim 8, further comprising instructions that, upon execution by the processor, cause the system at least to receive fourth information relating to a positional state of the one or more machines, wherein the suitable pairing is determined based upon at least the first information, the second information, the third information, and the fourth.

14. The system of claim 13, wherein the fourth information comprises one or more of a location, heading, and speed of the one or more machines.

15. A computer-implemented method comprising:
receiving, by one or more processors, first information relating to an availability of one or more machines of a plurality of machines;
receiving, by the one or more processors, second information relating to a machine role of the one or more machines;
receiving, by the one or more processors, one or more of third information relating to a pairing state of the one or more machines and fourth information relating to a positional state of the one or more machines;
determining, by the one or more processors, a suitable pairing for at least one of the plurality of machines based upon at least the first information, the second information, and the third information; and
establishing a pairing between two or more of the plurality of machines.

16. The method of claim 15, wherein the first information comprises one or more of a proximity to other machines of the plurality of machines, maintenance schedule, current site tasks, operator information, and pairing capability.

17. The method of claim 15, wherein the machine roles relate to operational capabilities of the one or more machines.

18. The method of claim 15, wherein the third information comprises a paired state or an unpaired state.

19. The method of claim 15, wherein the third information comprises an identifier of machine pairings.

20. The method of claim 15, wherein the fourth information comprises one or more of a location, heading, and speed of the one or more machines.
